(19) United States
(12) Patent Application Publication
(10) Pub. No.: US 2008/0054580 A1
(43) Pub. Date: Mar. 6, 2008

(54) Glaser equipment transporter

(76) Inventor: Robert L. Glaser, Stanton, NE (US)

Correspondence Address: Robert L. Glaser, 806 3rd Street, Stanton, NE, 68779, US

(21) Appl. No.: 11/800,633

(22) Filed: Sep. 4, 2007

Related U.S. Application Data
(60) Provisional application No. 60/799,704, filed on May 11, 2006.

(51) Int. Cl. B62B 3/02

(52) U.S. Cl. 280/35

(57) ABSTRACT

The installation of equipment such as large medical autoclaves requires movement of the equipment from the palletized shipping container to the final installation point in a typically medical facility. In the past, methods used to move the equipment involved major dis-assembly of the associated piping, electrical, and control components typically found inside and adjacent to the equipment. Once the unit was stripped of external components, the main portion of the unit would be jacked and blocked until it was free of the shipping pallet. It would then be moved by devices not intended for moving medical equipment. The aforementioned methods were commonly time-consuming, prone to damage the equipment, and presented safety hazards to the installation contractors. The following claim describes a device, hereafter known as “Glaser Transport” that is designed for controlled lifting, moving, and lowering of large equipment, typically medical autoclaves, medical sterilizers, and other large non-typical equipment. The goal of the “Glaser Transport” is to provide a safe and effective method of lifting, moving, and lowering large, unwieldy equipment of over 500 pounds.

### DEFINITIONS

“Glaser Transport”—The item under review in this claim.

“Autoclave” A device used to create a super-heated environment for sterilization medical equipment. The Autoclaves referenced in this claim may include models that weigh between 3000 and 8000 pounds each.

“Sterilizer” Another term for Autoclave

“The Pit” Large Autoclaves and Sterilizers are nominally mounted on the floor in a depressed area to allow for spilled water capture or condensate. These depressed areas are nominally 4 to 12 inches deep.

### BACKGROUND OF THE INVENTION

The installation of equipment such as large medical autoclaves requires movement of the equipment from the palletized shipping container to the final installation point in a typically medical facility. These facilities may include, but not limited to, Hospitals, University Research Labs, Medical Instrument Manufacturers, or other facilities that perform large scale sterilization of tools or instruments.

In the past, methods used to move the equipment for installation involved major disassembly of the associated piping, electrical, and control components typically found inside and adjacent to the equipment. Once the unit was stripped of external components, the main portion of the unit would be jacked and blocked until it was free of the shipping pallet. The aforementioned methods were commonly time-consuming, prone to damaging the equipment, and presented safety hazards to the installation contractors.

The equipment nominally arrives at the facility palletized and is typically moved from shipping truck to loading dock with large forklift equipment. The shipped equipment normally cannot be tipped or tilted past a few degrees of vertical due to safety considerations. It is often top-heavy. The equipment being moved is commonly too large to fit through a standard doorway opening on or in the original shipping container/pallet. Once unpacked, the equipment typically has no carrying handles, integrated lifting points, casters or wheels.

The “Glaser Transport” was developed to provide a method of securing lifting aids around the equipment through the use of custom designed brackets that comprise a system capable of lifting the equipment off of the pallet and transporting it to the final installation location.

Once at the installation point, the equipment is typically installed in a “pit”—a lowered depression in the floor to contain condensation or water. Typically, the equipment is lowered into the pit the same way that it is lifted off of the pallet—with jacks and blocks. This presents a safety hazard to the installation contractor as people are required to be in the pit with the equipment. The “Glaser Transport” provides a method for moving the equipment into place in the pit without endangering the safety of the workers.

The following sections will detail the “Glaser Transport” construction, and use. It will be shown that no current commercially available product is available to perform the tasks indicated in this document.

### DESCRIPTION OF THE INVENTION

The “Glaser Transport” consists of the following components:

The entire “Glaser Transport” may have the option of powered movement through the use of one or more drive wheels.

All of the equipment needed to provide locomotion of the “Glaser Transport” may be contained in a device separate from the actual lifting and rolling components.

Manual locomotion of the “Glaser Transport” through the use of human strength is also supported. The maximum weight in this configuration may be limited due to the resistance of the flooring surface being traversed (hard concrete vs. Soft carpet), and the amount of people available to safely handle the load.

The entire construction of the “Glaser Transport” is described in paragraphs [0048] thru [0072] attached.

The general construction in description is as follows:

Four large lifting units using screw jacks are used on the corner of the device.

Alternate lifting units may be hydraulic or air driven. The principle is the same.

Typically, two (2) end units are used consisting of two (2) lifting units each tied together.

The end units may have wheels to facilitate movement of the device. Typically they are standard heavy duty caster-type wheels, but may be fixed position on one of the end units to provide stability and the ability to drive the transport

The dimensions of the end units of the “Glaser Transport” are variable to allow custom sizing to various equipment being transported. The closer the lifting units are to the unit under transport, the more stable the transport will be.

The two (2) side irons are used to provide attachment points for the hangers. There may be different lengths of side irons to facilitate different lengths and depths of equipment being transported. The hangers also supply attachment points for under body support irons.

The support irons are constructed of heavy wall steel tubing with additional internal support provided by cold-rolled steel tubing shaft inserted inside the side irons.

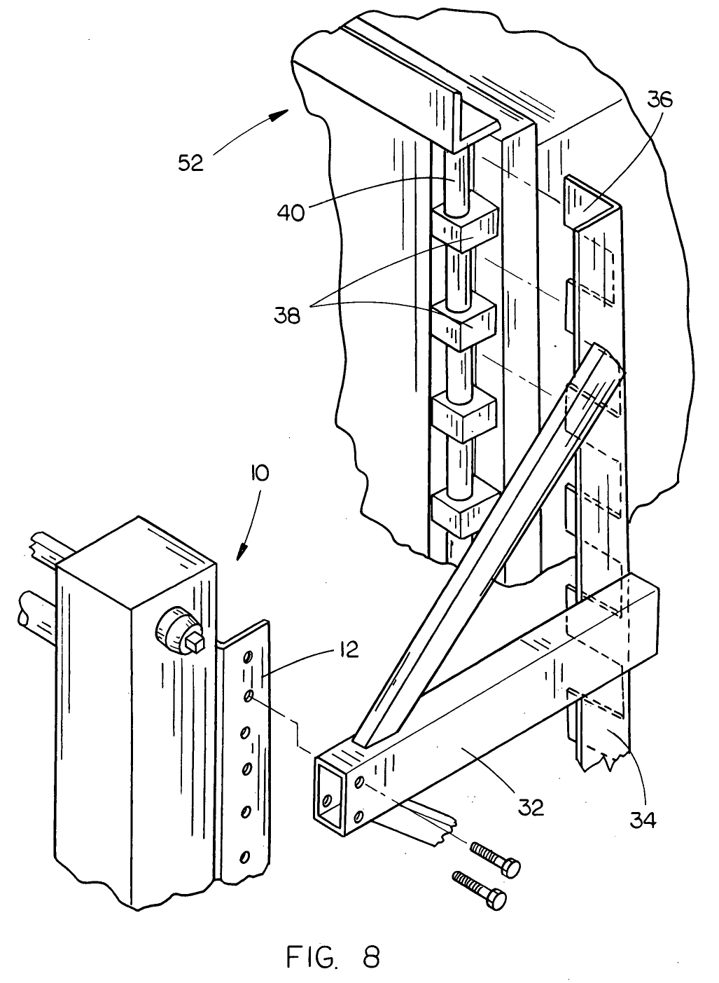

The “Glaser Transport” is adaptable to accommodate various models of medical Autoclaves and Sterilizers. Brackets (FIG. 8A may be attached to the end units (10A) to provide a means of attaching the transporter to the front and rear of a unit. Additional chains and load binders may be used to secure various models of Autoclaves.

The “Glaser Transport” may also be used to remove medical Autoclaves and Sterilizers in the same manner in which it is used to install the equipment. The same advantages in safety and efficiency are realized because minimal disassembly is required before the old equipment is removed from the pit. Often there are hazardous conditions that develop when the equipment has been in place for a long period of time. Mold, excessive dirt, and bacterial deposits are present in areas that would require extensive contact by the contractors performing the removal. By minimizing the amount of system disassembly, The “Glaser Transport” can move the equipment from the area quickly and efficiently.

The operator of the “Glaser Transport” will either walk along with the unit, or may be carried on a platform attached to the drive unit.

The foregoing description of a preferred embodiment of the invention has been presented for purposes of illustration and description, and is not intended to be exhaustive or to limit the invention to the precise form disclosed. The description was selected to best explain the principles of the invention and practical application of these principles to enable others skilled in the art to best utilize the invention in various embodiments and various modifications as are suited to the particular use contemplated. It is intended that the scope of the invention not be limited by the specification, but be defined by the claims set forth below

1. The solution presented in the invention provides secure safe transport for lifting, moving, and lowering of bulky equipment that normally has no defined external case or covering other than the control panels and door assemblies.

2. The method employed by the invention for lifting, moving, and lowering the equipment is unique in the field of equipment lifting and moving devices.

3. The method described by this specification for limiting the disassembly of equipment prior to lifting, moving, and lowering is directly attributable to the use of the invention

### CONSTRUCTION OF THE INVENTION

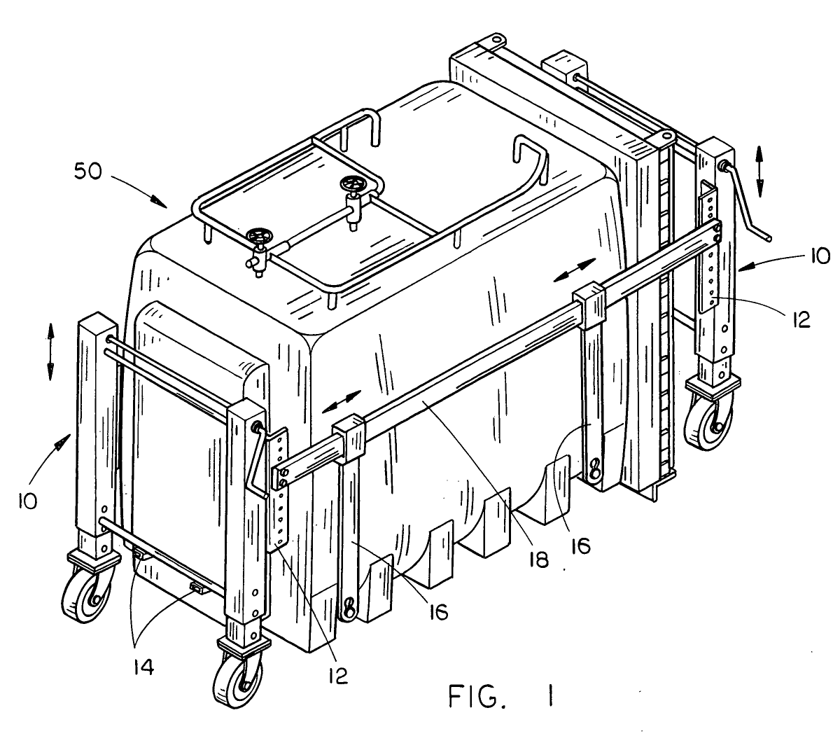

Two [2] end units are constructed as shown “FIG. 1A” each unit consists of two [2] sets of columns [jacks] mounted vertically on wheels.

The columns are capable of being raised and lowered with approximately 36 inches of travel.

Additional height adjustments are pictured FIG. 2A and optional extensions not shown may be added if desired to increase vertical travel.

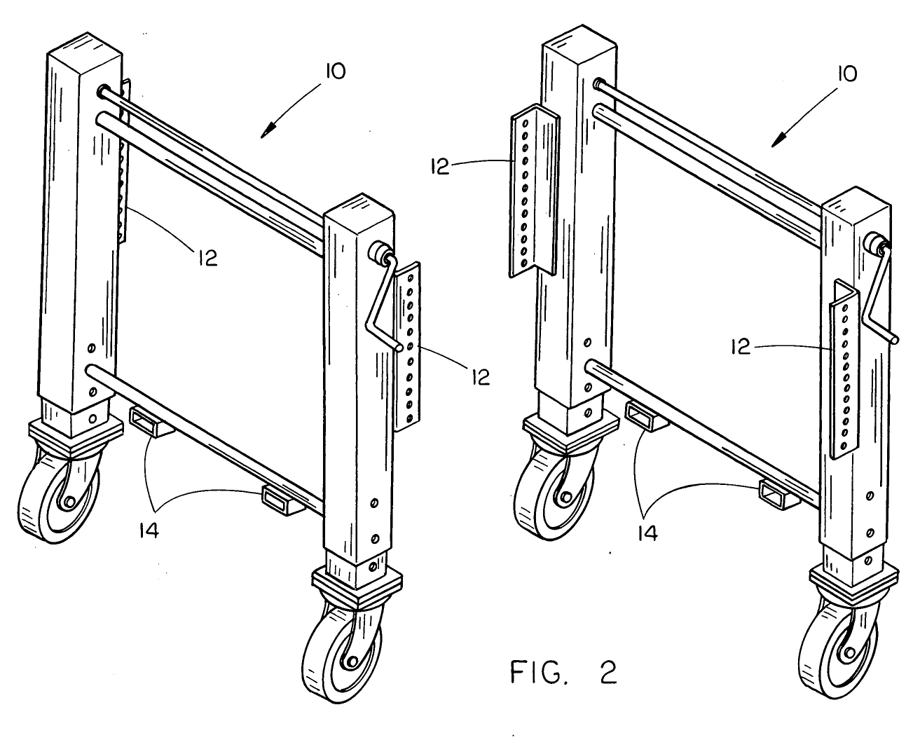

“FIG. 3A” shows the location that special adapters are fastened to these said end units.

There are Three [3] types of said adapters for autoclaves.

These are designated as older 42-72, single or double door series, and newer 800-83 series.

For the older 42-72 series, the adapters are referred to as ‘clamps’

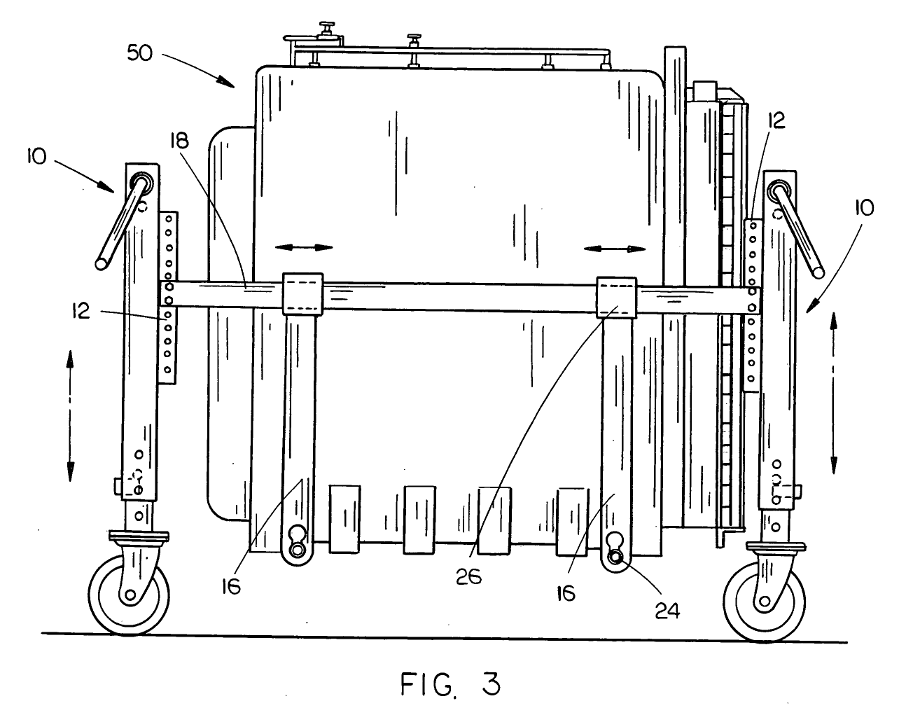

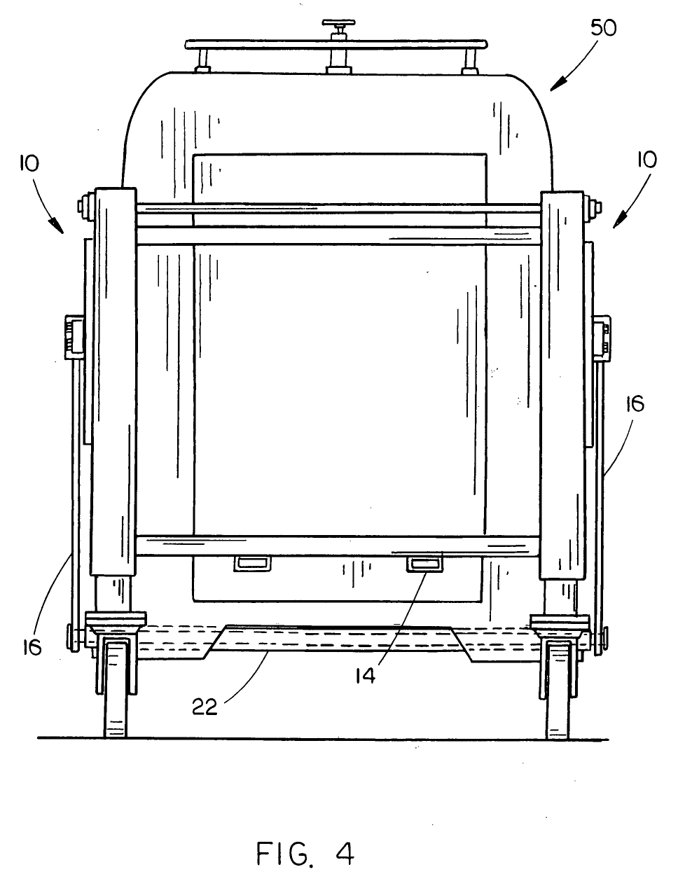

There are two[2] clamps per set, and one set per application. these said clamps are Pictured “FIG. 4A”

These clamps are attached to the door end of the autoclave as follows.

The said clamps, —door hooks/shafts/and lugs, are pictured “FIGS. 5A and 8A” The door components “FIG. 5A” and the clamps “FIG. 4A”

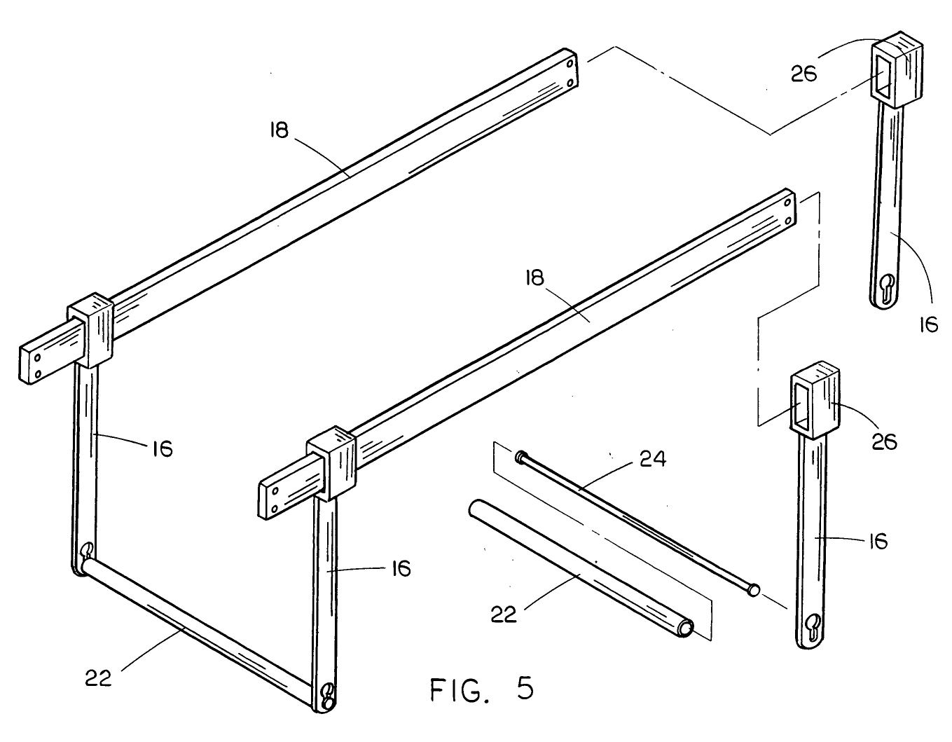

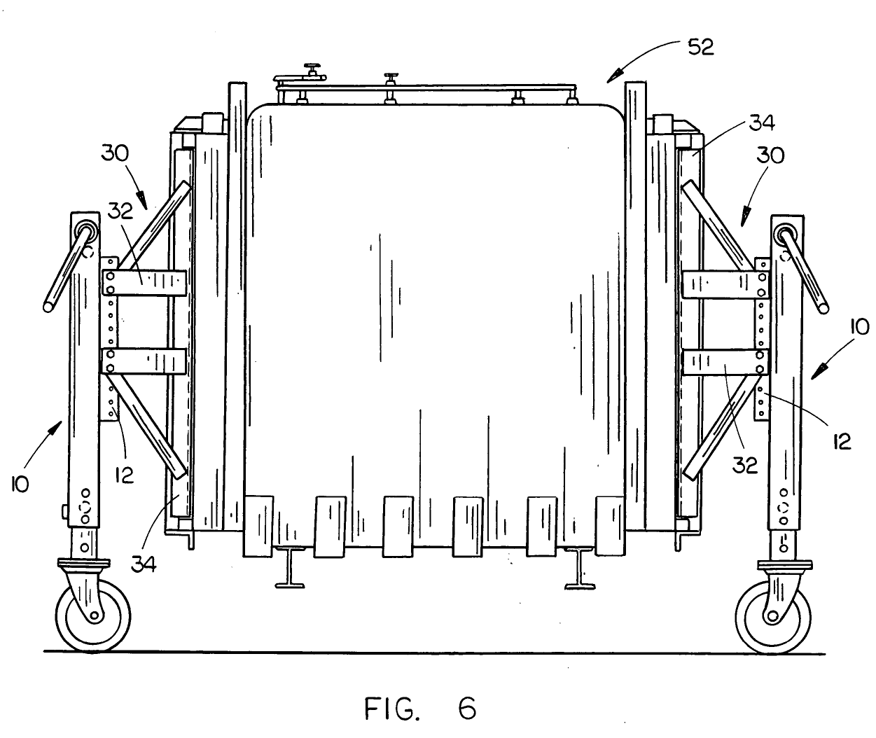

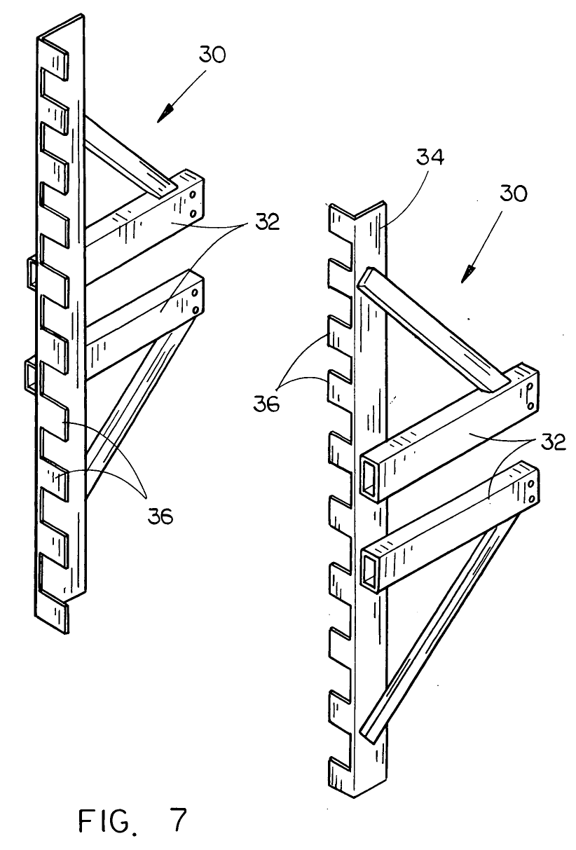

The clamps slide behind the hooks and shafts, “FIG. 6A” and the Vertical lift is provided by the cutouts of the clamps, “FIG. 7A” lifting at points shown “FIG. 8A”—a side view of said door hooks/shafts/lugs.

These clamps are connected to the said end units by fastening points 8A to 3A

A double door model of the 42-72 series would have a set of these clamps on each end [door]

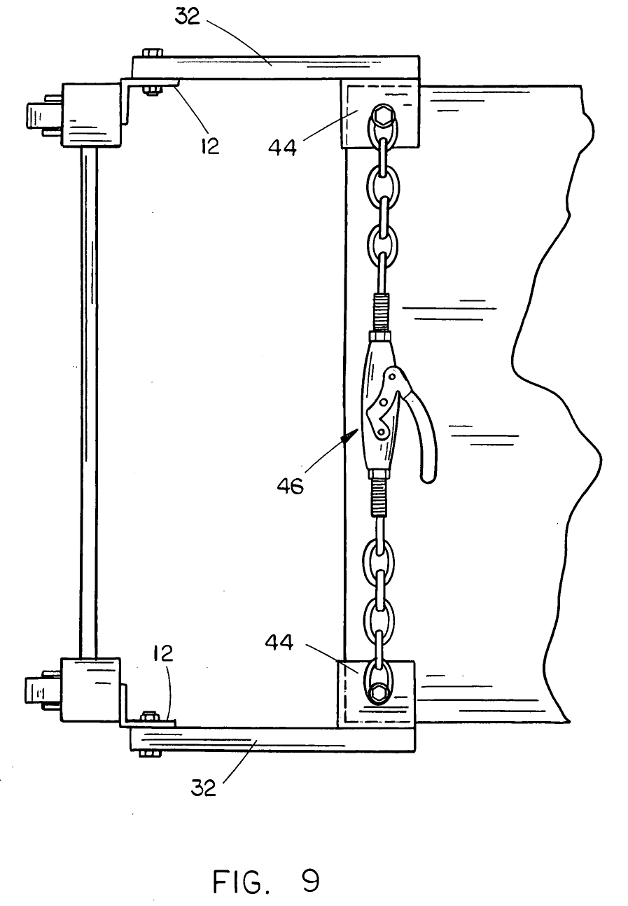

For a single door model of the 42-72 series, FIG. 9A illustrates that a set of ‘clamps ’ fit around the edges on the back of the autoclave, FIG. 21A and a chain secures them on the bottom to a structural foot of the autoclave. These same clamps are also secured across the top of the unit as shown FIG. “10A”

Secured top and bottom, these clamps are fastened to the end of the sterilizer as shown FIG. “11A” The autoclave can then be lifted, lowered, and moved at will.

The adapters for the newer 800-83 series autoclave are shown on pages FIG. 12A thru 18A

FIG. 12A shows the side irons fastened to the end units as an assembly.

“FIG. 13A” shows the side irons. side view. FIG. 14A the end view,

FIG. 15A Shows how the vertical irons are—hung—or attached to the side irons

FIG. 16A shows the bottom support. There are two [2] of these supports, located at FIG. 17A

“FIG. 18A” shows the method of attachment between the vertical hanger, and the bottom supports.

The autoclave is suspended by the bottom supports at points shown on “FIG. 19A”.

On the newer 800-83 series autoclave, single or double doors use the same method of attaching the transport.

This entire assembly is made for assembly or disassembly in confined areas where this type of equipment is normally located.

“FIG. 20A” shows connections for a detachable tow bar for a powered vehicle

I claim

1. A device for moving different models of large autoclaves.
[sterilizers]
[a] Two units, each consisting of two columns mounted vertically on wheels and said columns able to be raised and lowered
[b] Two horizontal members attached between said units from which hangers are supported and carry said autoclave or
[c] vertical members that attach to said units and hook or clamp on front and rear of said autoclaves
[d] A means of attaching a powered device for moving said assembly
[e] Where by the use of this device will enable the user to move said autoclave easier and safer than previous methods
